(19) United States
(12) Patent Application Publication
(10) Pub. No.: US 2002/0013810 A1
(43) Pub. Date: Jan. 31, 2002

(54) Electronic document mapping

(76) Inventor: Pang Hwee Hwa, Singapore (SG)

Correspondence Address: Peter J. Davis, Morrison & Foerster LLP, 2000 Pennsylvania Avenue, Washington, DC, 20006-1888, US

(21) Appl. No.: 09/835,856

(22) Filed: Apr. 17, 2001

(30) Foreign Application Priority Data
Apr. 17, 2000 (SG) 200002256-6

(51) Int. Cl. G06F 15/16

(52) U.S. Cl. 709/203; 709/245

(57) ABSTRACT

A method of mapping the identity of at least one electronic document, the at least one electronic document having a resource locator, the method including the steps of:

(a) receiving a request for an alias of the resource locator from a client;

(b) recovering the resource locator from the alias resource locator,

(c) retrieving the at least one electronic document at the resource locator;

(d) creating a new alias resource locator; and

(e) returning the electronic document under the new alias resource locator to the client.

### FIELD OF THE INVENTION

This invention relates to electronic document mapping and refers particularly, though not exclusively, to a method for mapping the identity of at least one electronic document to reduce the impact of unwanted messages on the electronic document. Additionally or alternatively, the present invention relates to a method of categorizing attachments on at least one electronic document according to one or more factors.

### BACKGROUND TO THE INVENTION

With the significant grow in electronic commerce the number of web pages and home pages on the internet has increased significantly. Over the last twelve months, users have been given the ability to link attachments to web pages using a service such as, for example, Third Voice, Gooey or uTok. Such attachments, once created, can only be removed by the service—not the user or the web page owner. Whenever an unwanted attachment is left on a web page, the owner of the web page has to withdraw and replace the web page. This can take time and therefore may impact on the business of the web page owner.

Codes can be embedded into web pages to reduce the impact of such an attack, but these codes must be separately inserted into every web page to be effective. Also, it is possible to disable the code at the browser.

Furthermore, the owner of the web page may wish to group subscribers into communities.

### CONSIDERATION OF PRIOR ART

U.S. Pat. No. 5,835,718 of Blewett. This discloses a method for real-time rewriting of a URL in an inter-connected computer system network which includes the steps of defining a pseudo proxy server and rewriting the URL

The rewritten URL is sent to a local user. The system determines if a selected URL is a selected rewritten URL. It is further required that the rewritten URL be “blind” to a user, and not be easily decoded by the user, so that the user cannot easily defeat the rewriting mechanism. To enable the user's environment to remain unchanged, a URL that is not rewritten behaves as usual. The rewriting of the URL's is a remapping of selected record identities from one (local) domain to another (remote) domain. If the domain name of a selected URL is remote when compared to a local domain name in a table of local domain names, the remote URL is replaced by an opaque local URL. Indices that are private to the HTTP server are used to prevent the user generating or reconstructing the remote URL.

The generation of the indices is accomplished from a local register, an incremented integer, or memory address from where the string is stored in a database, the inode of a disk file, or a simple disk file name. The conversion of the proxy URL can be done by using indices. The number is an index into an array where the actual remote URL is stored, utilizing a minimal perfect hash. The indices also provide a simple way of tracking access to the remote URL's.

U.S. Pat. No. 5,961,645 of Baker. This discloses the approaches used to filter naming ambiguities of URL's in a filter and is directed to the problem that URL's are not unique identifier resources. Distinct URL's can name the same resource in that user requesting these URL's will receive identical resources in response, and repeated requests for a single URL may result in the user receiving different resources at different times. The method proposed involve the use of a database which is queried upon receipt of a request for a resource from a user, and upon a response being received from the resource.

U.S. Pat. No. 5,751,956 of Kirsch. This directed to the determination of the number of times a hyper-linked URL located in a web page is activated by users. This is achieved by using a web server computer system that provides a client system with a predetermined URL reference to the web server system, encoded with predetermined redirection and accounting data including a reference to a second server system. Upon receipt of the predetermined URL reference, the predetermined redirection and accounting data is decoded from the URL and processed by the web server system. The web server provides the client system with a redirection message including the reference to the second server system. Accounting data is processed by the web server and resulting data is selectively stored by the web server.

U.S. Pat. No. 5,812,776 of Gifford. This invention relates to methods of processing service requests from a client to a server through a network using a non-URL description. By use of a translation database, the non-URL description is mapped to the correct web page. The only security aspects mentioned are the use of a user name and password.

U.S. Pat. No. 5,937,066 of Gennaro et al. This patent discloses a system for handling key recovery in an encryption system whereby a portion of the key recovery information is generated once only and is used for multiple encrypted data communications sessions and encrypted file applications. That portion of the key recovery information that is generated once only is the portion that requires public key encryption operations. The information encrypted under the public keys of the key recovery agents (the information that a requesting party would eventually provide to a key recovery agent in order to effect the step of key recovery) is a set of randomly generated keys. These are independent of, and unrelated to, the keys intended to be protected and recovered using the key recovery protocol.

U.S. Pat. No. 5,806,079 of Rivette et al. In this patent notes in relation to data objects are linked to the data objects. A number of levels of sub-notes are linked to different portions of the data objects. When a user views a note or sub-note, upon request, they can be connected to the relevant data object or portion of the data object. The notes and sub-notes are grouped, and all or part of the note database may be encrypted. In some embodiments, the object identifier field, the location identifier field, and the range field are encrypted. Also, the link address contained in the link address field of the entry in the note information database may be encrypted. Therefore, the note engine encrypts the link address before storing it in the link address field of the entry in the note information database. In other embodiments, the link address in the link address field of the note information database, object identifier field, location identifier field, and range field in the note/object linking information database are encrypted, The note application retrieves the link address from the link address field and decrypts the link address. The decrypted link address is used as an index into the notes/object linking information database to identify the entry corresponding to the entry being processed in the note information database. The linked data object is identified by the information in the object identifier field, location identifier field, and the range field of the corresponding entry. Before it can use this information, the notes application decrypts the object identifier field, location identifier field, and range field. This decrypted information is used to identify the linked portion in the data object.

U.S. Pat. No. 5,870,477 of Sasaki et al relates to an encryption/decryption process whereby a plaintext file is encryphered using a file key, which is encyphered to form an encyphered key using a secret key and a management key. An encyphered file is produced from the cyphertext, the enciphered key and the management key. To enable decryption to take place, the enciphered key is taken from the encyphered file and decyphered using the secret key to thereby obtain a file key. The cyphertext is decyphered using the file key to obtain the plaintext, The nature of the symmetric and asymmetric cyptosystems used is not of importance nor is it of importance the nature of a block cypher and stream cypher which is used. The secret key is generated in a number of different ways such as, for example, from an encyphered password of an operation.

“SecureWay Firewall”, version 4.1 available from http://www-4.ibm.com/software/secureway where there is disclosed the implementation of many-to-one Network Address Translation (NAT) to enable internal IP addresses to a single registered IP address. The internal IP addresses are not visible while in transit over a public network. A technique called Network Address Port Translation is employed to implement this function. NAT support is also enhanced to include translation of ICMP. See also “SecureWay firewall version 4.1” Information Security, November, 1999.

In “The Seybold Report on Internet Publishing”, January 1998 at page 21, there is discussed the operation of the “LiveLink” link generation and management software from LiveLink Systems, Ltd. This software runs “HyTime” link management for the automatic generation of tables of contents, indices and alising so that, for example, a reference to “oil gauge 33” can be linked to the common name “dipstick”.

“Special Report: Extending the Enterprise”, “Byte” December 1997, page 65 discloses the generation of a sequence of one-time passwords with a one-way hashing unction (i.e. a function that modifies input so that it can't be determined simply from the output). S/Key usually uses the MD5 message digest function to generate a list of one-time passwords for a user.

None of the prior art publications, individually or in any combination, suggest or even address the problem of providing an adversarial system to combat the leaving of unwanted, undesirable or obscene messages on web pages.

Futhermore, none of the prior art addresses the need for the owner/operator of a web page to group subscribers into different communities.

### DEFINITION

Throughout this specification, a reference to an attachment on an electronic document such as a web page is to be taken as including a reference to a message or a chat room that is linked to the electronic document and includes a message left on the electronic document without the knowledge, consent, approval or permission of the electronic document owner or operator. Messages left using a service such as, for example, Third Voice, Gooey or uTok are included within this definition.

Throughout this specification map, mapping and their derivates are used in the sense that a computer can map an address to another address.

### OBJECT OF THE INVENTION

It is the principal object of the present invention to provide a mapping method for electronic documents, particularly for mapping the identity of a web page, more particularly to reduce the impact of unwanted attachments on the web page.

A further object is to allow the owner of the web page to be able to categorize attachments on the web page according to one or more factors.

### SUMMARY OF THE INVENTION

With the above and other objects in mind the present invention provides a method of mapping the identity of at least one electronic document, the at least one electronic document having a resource locator, the method including the steps of:

(a) receiving a request for an alias of the resource locator from a client;

(b) recovering the resource locator from the alias resource locator;

(c) retrieving the at least one electronic document at the resource locator;

(d) creating a new alias resource locator; and

(e) returning the electronic document under the new alias resource locator to the client.

In an alternative form, the present invention provides a method of categorizing at least one attachment on at least one electronic document, the at least one electronic document having a resource to cater, the method including the steps of:

(a) receiving a request for an alias of the resource locator from a client;

(b) recovering the resource locator from the alias resource locator;

(c) retrieving the at least one electronic document at the resource locator;

(d) creating a new alias resource locator; and

(e) returning the electronic document under the new alias resource locator to the client.

Advantageously, the at least one electronic document is located on a first server, and the client operates a browser. More advantageously, upon the at least one electronic document being returned to the client, the browser computes an identifier from the new alias resource locator. Preferably the identifier is computed from the new alias resource locator and the content of the at least one electronic document.

Upon the identifier being computed, it is sent to an attachment server on which is located at least one attachment to the at least one electronic document. Upon the attachment server receiving the new identifier it retrieves the at least one attachment using the new identifier. The at least one attachment may then be returned to the browser, whereupon it may be displayed by the client.

The electronic document may be a web page, and the resource locator may be a URL. The at least one attachment may be an unwanted note, a chat room, or an electronic bulletin board.

By selecting a new alias resource locator randomly, the browser is redirected to a different alias resource locator each time.

Preferably, random perturbations are introduced into the at least one electronic document prior to returning the document in step (e). More preferably, the random perturbations are a number of invisible characters. Advantageously, the number of invisible characters is selected arbitrarily. The random alias resource location together with the random perturbations in the electronic document, causes the identifier to be different each time. Consequently, the attachments meant for the same electronic document are scattered, as they are stored with different identifiers.

Advantageously, the new alias resource locator varies according to a network address of the browser. Preferably, the new alias resource locator varies according to the client identity.

### DESCRIPTION OF THE DRAWINGS

In order that the invention may be fully understood and readily put into practical effect, there shall now be described preferred embodiments of the present invention, the description being with reference to the accompanying illustrative drawings in which:

FIG. 1 is a schematic illustration of a network in which the present invention is applicable; and

FIG. 2 is a flow chart representing the basic steps in the method of the present invention.

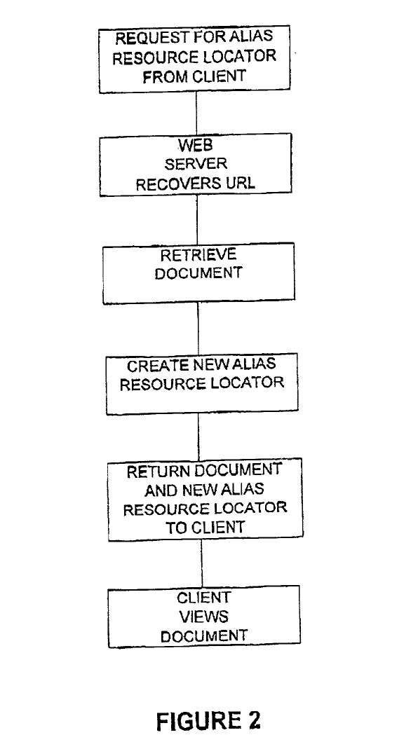

### DESCRIPTION OF THE PREFERRED EMBODIMENTS

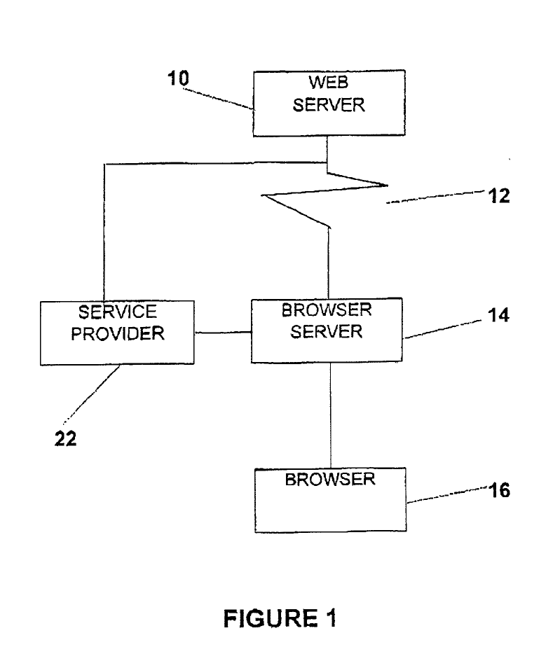

To refer to FIG. 1, there is a server 10 in a network, the server 10 hosting a number of web pages, each web page having a Universal Resource Locator (URL). The web server 10 is connected to the internet 12. Also connected to internet 12 is a user's browser 16, via the proxy server 14. All of this is well known. As has been referred to earlier, in the past year a service provider 22 (such as, for example, Third Voice) can enable the browser 16 to post attachments, being a form of message or chat room, on a web page hosted by web server 10. Such attachments cannot be removed by the owner or operator of the web page, or by the browser 16 who placed it there—only the service provider 22 can remove the unwanted message.

Upon a browser 16 making a request for a web page in server 10 via the proxy server 14 and internet 12 by reference to the URL of that web page, the web page is recovered from the server 10. The server 10 then generates an index I into an array of N secret keys KEY.

The canonical URL of the web page is then encrypted using the secret key KEY [I] to produce CRYPTSTR. If the web page has a root URL address BASEURL, the alias URL is BASEURL-(I, CRYPTSTR). The requested web page is then returned to the browser 16 under its alias URL.

If the browser 16 requests an alias URL, the request is sent to the web server at BASEURL, with an argument-(I, CRYPTSTR). Thc web server 10 recovers the canonical URL by decrypting CRYPTSTR with the key KEY [I]. The canonical URL link of the web page is then encrypted using a new key KEY [J] by generating a new index J into an array of N secret keys KEY [ ].

The web page is then mapped into an alias URL BASEURL-(J, CRYPTSTR) and the web page returned to browser 16 under its alias.

The mapping of the web page to the alias may be by any known means. The alias generated may be generated from the network address of the user's browser.

Preferably, the server 10 can map only the canonical URL of the web page.

The generation of the indices I and J may be by any known means, including randomly.

If the browser 16 were to use service provider 22 to leave an unwanted attachment on the web page in server 10, the web page with the unwanted attachment has already been mapped to a different alias URL, by encrypting the canonical URL with a randomly chosen secret key. As there are N secret keys in the array, unwanted attachments on the same web page would be mapped to N different alias URLs. Without knowing all the secret keys KEY [N], it is impossible for browser 16 or service 22 to collate the different alias URLs because they cannot know whether two arguments (I₁, C₁) and (I₂, C₂) refer to the same underlying web page.

Therefore, even though the browser 16 can access the web page through any of its N alias URLs, security still prevails. Furthermore, the browser 16 can also bookmark the web page through any of its N alias URLs.

It is preferred that in addition to returning a randomly chosen alias URL, random perturbations are introduced into the web page to further confuse the browser 16 and server 22. The perturbations may include, for example, invisible characters.

Alternatively, the attachments on a web page may be categorized according to one or more factors. These factors can include network address and user identity. This can be achieved by the document server 10 selecting the new alias URL based on the relevant factors. If by network address, for example, it may be possible to categorize attachments by the network segments or user identity. If by user identity the categorization may be by user communities.

Whilst there has been described in the foregoing description a preferred form of mapping the identity of at least one electronic document and/or categorizing attachments on at least one electronic document, it will be appreciated by those skilled in the technology concerned that many variations or modifications in specific details may be made without departing from the present invention.

1. A method of mapping the identity of at least one electronic document, the at least one electronic document having a resource locator, the method including the steps of:
(a) receiving a request for an alias of the resource locator from a client;
(b) recovering the resource locator from the alias resource locator;
(c) retrieving the at least one electronic document at the resource locator;
(d) creating a new alias resource locator; and
(e) returning the electronic document under the new alias resource locator to the client.

2. A method of categorizing at least one attachment on at least one electronic document, the at least one electronic document having a resource to cater, the method including the steps of:
(a) receiving a request for an alias of the resource locator from a client;
(b) recovering the resource locator from the alias resource locator;
(c) retrieving the at least one electronic document at the resource locator;
(d) creating a new alias resource locator; and
(e) returning the electronic document under the new alias resource locator to the client.

3. A method as claimed in any one of claim 1 or claim 2, wherein the at least one electronic document is located on a first server, and the client operates a browser such that upon the at least one electronic document being returned to the client, the browser computes an identifier from the new alias resource locator.

4. A method as claimed in claim 3, wherein the identifier is computed from the new alias resource locator and the content of the at least one electronic document.

5. A method as claimed in claim 4, wherein upon the identifier being computed it is sent to an attachment server on which is located at least one attachment to the at least one electronic document.

6. A method as claimed in claim 5, wherein upon the attachment server receiving the identifier it retrieves the at least one attachment using the identifier.

7. A method as claimed in claim 6, wherein there is the additional step of returning the at least one attachment to the browser.

8. A method as claimed in claim 7, wherein upon the at least one attachment being received by the browser it can be viewed by the client.

9. A method as claimed in claim 1 or any one of claims 3 to 8 when appended to claim 1, wherein the new alias resource locator created in step (d) is created randomly.

10. A method as claimed in claim 1 or any one of claims 3 to 9 when appended to claim 1, wherein random perturbations are introduced into the at least one electronic document prior to returning the at least one electronic document in step (e).

11. A method as claimed in claim 10, wherein the random perturbations are a number of invisible characters.

12. A method as claimed in claim 11, wherein the number is selected arbitrarily.

13. A method as claimed in claim 2 or any one of claims 3 to 8 when appended to claim 2, wherein the new alias resource locator varies according to a network address of the browser.

14. A method as claimed in claim 13, wherein the at least one attachment is grouped by network segments.

15. A method as claimed in claim 2 or any one of claims 3 to 8 when appended to claim 2, wherein the new alias resource locator varies according to client identity.

16. A method as claimed in claim 15, wherein the at least one attachment is grouped by client communities.

17. A method as claimed in any one of claims 1 to 16, wherein the at least one electronic document is a web page.

18. A method as claimed in any one of claims 1 to 17, wherein the resource locator is a URL.

19. A method as claimed in any one of claims 1 to 18, wherein the attachment is an electronic note.

20. A method as claimed in any one of claims 1 to 18, wherein the attachment is an online chat room.

21. A method as claimed in any one of claims 1 to 18, wherein the attachment is an electronic bulletin board.
